(19) United States
(12) Patent Application Publication
(10) Pub. No.: US 2026/0119839 A1
(43) Pub. Date: Apr. 30, 2026

(54) RECEIVER FOR DATA DECOMPRESSION WITH AUTO-ENCODER ENHANCEMENT

(71) Applicant: VALEO VISION, Bobigny (FR)

(72) Inventor: Yasser ALMEHIO, Bobigny (FR)

(73) Assignee: VALEO VISION, Bobigny (FR)

(21) Appl. No.: 19/120,919

(22) PCT Filed: Oct. 13, 2023
(86) PCT No.: PCT/EP2023/078545

§ 371 Date: Apr. 14, 2025

(30) Foreign Application Priority Data
Oct. 15, 2022 (FR) FR2210640

(51) Int. Cl. G06N 3/0455; G06N 3/0464; G06N 3/09

(52) U.S. Cl. CPC G06N 3/0455; G06N 3/0464; G06N 3/09

(57) ABSTRACT

The invention relates to a receiver which includes a memory storing a first auto-encoder convolutional neural network capable of obtaining enhanced data from compressed data, a first interface capable of receiving compressed data via a communication channel, a processor configured to decompress the data into decompressed data, and to apply the first auto-encoder convolutional neural network to the compressed data in order to obtain enhanced data, and a second interface capable of transmitting the enhanced data.

### TECHNICAL FIELD

The present invention relates to the field of reception and processing of data, in particular image data. The invention applies, particularly but not exclusively, to data exchanged in or by an automotive vehicle.

### BACKGROUND OF THE INVENTION

Data compression, in particular image data compression, is known for limiting the amount of data transmitted over a communication channel.

Some communication channels have a limited bandwidth. This is particularly the case with the CAN bus, although this type of communication channel is widely used because it is secure and inexpensive. This communication channel is used particularly in automotive vehicles, for example to transmit photometric images between a central control module of the vehicle and a lighting device of the vehicle.

The image data transmitted, including in automobiles, now have high resolutions. The same restriction on the throughput of the communication channel results in high compression ratios which can cause defects such as noise, artefacts, or a low PSNR in the images decompressed in the receiver. PSNR refers to the “Peak Signal to Noise Ratio”.

This is especially true in the case of lossy compression algorithms, such as linearization-based, gradient-based, JPG, PCA, or other algorithms. When these images are photometric images enabling control of an automotive vehicle lighting device, defects or artefacts affect the projected beam, especially as the resolution of the pixelated-beam lighting modules also becomes high. Such defects can cause safety problems and/or render the light beam non-compliant with a regulation.

### SUMMARY OF THE INVENTION

There is therefore a need to receive and process high-resolution image data via a communication channel which has a restricted throughput without causing substantial defects or artefacts in the images finally processed images in the receiver.

For this purpose, a first aspect of the invention relates to a data processing method comprising the following operations:

in a preliminary phase, supervised learning of a first auto-encoder convolutional neural network based on a first set of training data, the first set of training data consisting of image pairs comprising an image of a given quality and a com-pressed image obtained by compressing the image of a given quality, wherein the supervised learning is capable of minimizing a difference between an enhanced image obtained through the processing of a compressed image by the first auto-encoder convolutional neural network and the image of a given quality associated on a pair-by-pair basis with the compressed image;
storing said first auto-encoder convolutional neural network in a receiver.
During a current phase implemented by the receiver, the method further comprises:
receiving compressed data from a communication channel;
decompressing said compressed data into decompressed data;
applying the first auto-coder convolutional neural network to the compressed data in order to obtain enhanced data;
transmitting said enhanced data.

Such enhancement through artificial intelligence eliminates at least some of the defects in the decompressed data. Compression with a high compression ratio can thus be provided, and high-resolution data can therefore be transmitted via communication channels which have a restricted throughput.

Depending on embodiments, the decompression of said compressed data can use a linearization-based, gradient-based, JPG, or PCA decompression algorithm.

It is thus possible to enhance images compressed by compression algorithms. For this purpose, the first set of training data can advantageously comprise image pairs, with images compressed according to different compression algorithms. In practice, high levels of enhancement of images compressed by such algorithms can be achieved.

Depending on embodiments, decompression of compressed data can be implemented through processing by layers of neurons comprising an output layer and at least one convolutional hidden layer of a second auto-encoder convolutional neural network, said output layer comprising a first number of dimensions and said at least one convolutional hidden layer comprising a second number of dimensions, the second number of dimensions being smaller than the first number of dimensions.

The compression itself can thus originate from an auto-encoder, referred to as the second auto-encoder. The compression level can thus be controlled by setting the number of dimensions of the latent vector. Even with high compression levels, the enhancement provides high-quality enhanced data with few or no defects.

In addition, in the preliminary phase, the method can further comprise unsupervised learning of the second auto-encoder convolutional neural network based on a second set of training data.

The learning step is thus simplified for the second auto-encoder. The unsupervised learning can comprise, for example, optimizing the second auto-encoder in order to minimize a difference between input data and output data of the auto-encoder obtained after compression and decompression of the input data.

Depending on embodiments, compressed data and enhanced data can represent a photometry of an automotive vehicle lighting device.

It is important for regulatory and safety reasons to minimize defects in such photometric data. The use of enhancement according to the invention is then particularly advantageous.

In addition, enhanced data can be transmitted to a control module of an automotive vehicle lighting device.

The receiver can thus be advantageously implemented in a lighting device in order to control at least one of the lighting modules of the lighting device.

Additionally or alternatively, the compressed data can be received from a centralized control module of an automotive vehicle and the communication channel can be a CAN bus.

A communication channel of this type offers the advantage that it is secure and inexpensive. However, it has a restricted throughput and can require high compression ratios, making the use of the enhancement according to the invention particularly advantageous.

A second aspect of the invention relates to a receiver comprising:
a memory storing a first auto-encoder convolutional neural network capable of obtaining enhanced data from compressed data;
a first interface capable of receiving compressed data via a communication channel;
at least one processor configured to decompress the data into decompressed data, and to apply the first auto-encoder convolutional neural network to the compressed data in order to obtain enhanced data;
a second interface capable of transmitting the enhanced data.

A third aspect of the invention relates to a system comprising a receiver according to the second aspect of the invention, an encoder capable of receiving input data, com-pressing the input data into compressed data and transmitting the compressed data to the receiver via a communication channel.

Depending on embodiments, the encoder can be integrated into a central control module of an automotive vehicle, the receiver can be integrated into a lighting device of the automotive vehicle, the communication channel can be a CAN bus, and the input data can represent a lighting photometry.

### BRIEF DESCRIPTION OF DRAWINGS

Other characteristics and advantages of the invention will become apparent from an examination of the following detailed description and the attached drawings, in which:

FIG. 1 shows a data transmission system according to embodiments of the invention;

FIG. 2 shows the structure of a first auto-encoder convolutional neural network according to embodiments of the invention;

FIG. 3 is a diagram illustrating the steps of a data processing method according to embodiments of the invention;

FIG. 4 shows a data compression system using a second auto-encoder convolutional neural network according to one embodiment of the invention; and

FIG. 5 shows a structure of a receiver according to embodiments of the invention.

### DETAILED DESCRIPTION OF THE INVENTION

The description focusses on the characteristics that differentiate the methods, the system, the encoder and the decoder from those known in the prior art.

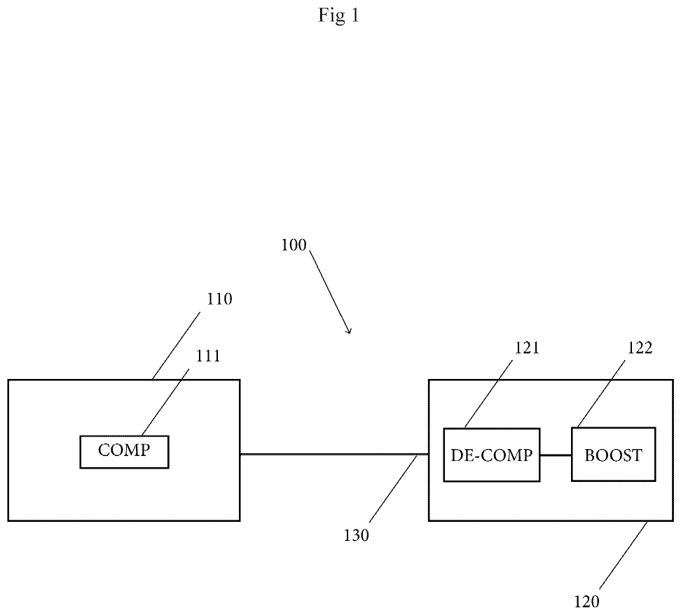

FIG. 1 shows a system 100 for transmitting data, in particular image data.

The system 100 comprises an encoder 110 and a receiver 120, connected by a communication channel 130.

The encoder 110 can be integrated into an automotive vehicle device, such as a control module responsible for the lighting of the automotive vehicle. Such a control module can, for example, be a PCM (Powertrain Control Module), or an ECU (Electronic Control Unit).

The receiver or decoder 120 can be integrated into an automotive vehicle device, such as a lighting device comprising lighting modules capable of performing lighting functions based on data communicated by the control module comprising the encoder 110. At least one lighting module of the lighting device is preferably a pixelated module, for example having a matrix of electroluminescent elements such as LEDs, having a matrix of micromirrors such as DMDs (Digital Micromirror Devices), a monolithic source of electroluminescent elements on the same substrate, or any other technology enabling the implementation of a pixelated lighting beam. A monolithic source involves a plurality of submillimeter-sized electroluminescent semiconductor elements epitaxied directly on a common substrate, the substrate being generally made from silicon. Unlike conventional LED matrices, in which each elementary light source is an individually produced electronic component mounted on a substrate such as a printed circuit (PCB), a monolithic source is to be regarded as a single electronic component, in the production of which several ranges of semiconductor electroluminescent junctions are generated on a common substrate, in the form of a matrix.

The communication channel 130 can thus be a wired link such as a CAN bus or Ethernet link. The example of a CAN bus is considered below by way of illustration. It offers the advantage of being a secure and inexpensive link. However, a CAN bus has a restricted throughput and requires the transmission of data as 8-bit encoded integers.

Alternatively, the encoder 110 is integrated into a control module of the automotive vehicle and the receiver 120 is integrated into a remote server of the automotive vehicle. In this case, the communication channel 130 comprises a wireless communication channel that allows the encoder to access an IP network in which the remote server comprising the decoder 120 is located. Such a wireless communication channel can be a 3G, 4G, 5G or any subsequent generation of cellular link.

No restrictions are imposed on the communication channel 130, which can be a wired or wireless link. As will be better understood from a reading of the description below, most communication channels have a restricted throughput of the data that they transmit.

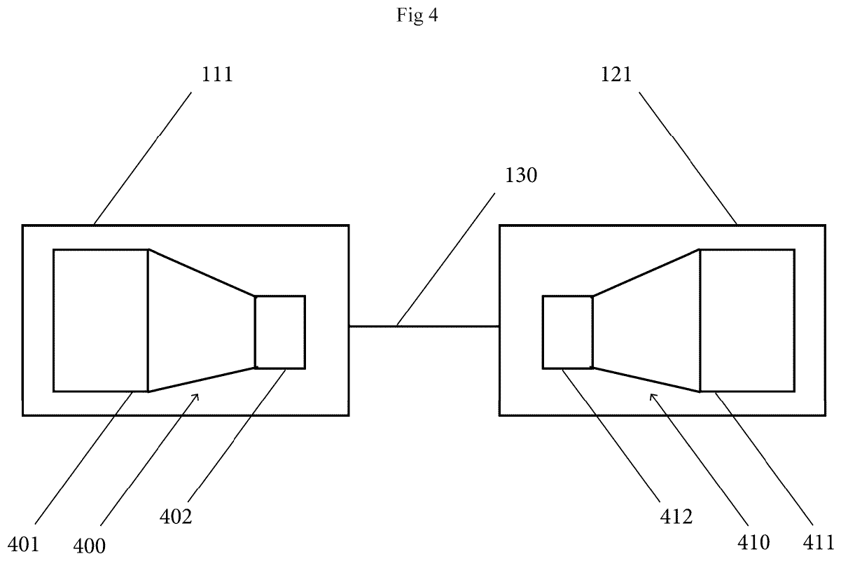

The 110 encoder comprises a data compression module 111 that is capable of receiving input data, such as data encoding an image, such as a photometric image, and of obtaining compressed data from the input data and from a data compression algorithm, such as a linearization-based, gradient-based, JPG, PCA, or other algorithm. Alternatively, the compressed data correspond to a latent vector of an auto-encoder convolutional neural network, as detailed below with reference to FIG. 4.

The decoder 120, or receiver 120, comprises a decompression module 121 corresponding to the decompression module 111 and capable of decompressing the com-pressed data received via the communication channel 130 in order to obtain decom-pressed data.

As mentioned earlier, when the compression ratio is high, for example greater than 80%, defects can appear in the images corresponding to the decompressed data. The invention then provides to add a software or hardware module 122 for enhancing the com-pressed data in order to obtain enhanced data having fewer defects than the decom-pressed data at the output of decompression module 121.

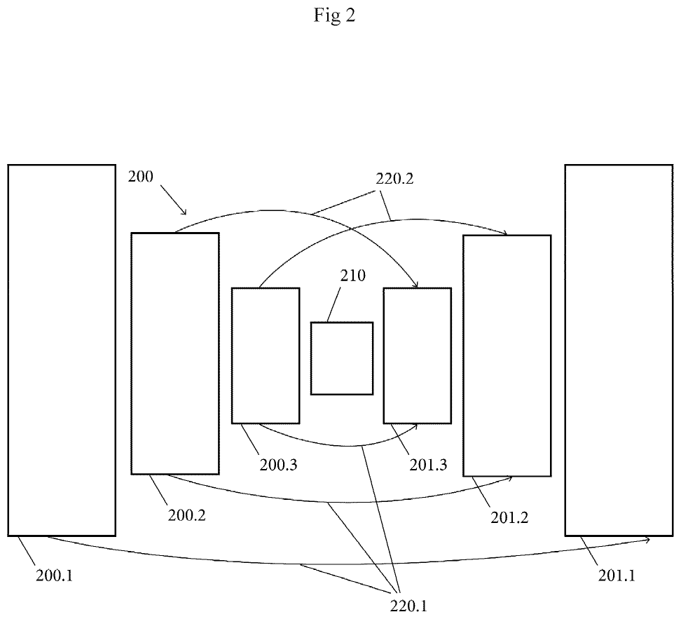

For this purpose, the enhancement module 122 can comprise a first auto-encoder convolutional neural network 200 described with reference to FIG. 2.

An auto-encoder convolutional neural network, also referred to below as an auto-encoder, comprises a plurality of layers of neurons, including an input layer 200.1, an output layer 201.1, at least one convolutional hidden layer of convolution, on the input layer 200.1, and at least one convolutional hidden layer of deconvolution, on the output layer 201.1.

In the example shown in FIG. 2, the first auto-encoder 200 comprises a first convolutional hidden layer 200.2 and a second convolutional hidden layer 200.3. The first auto-encoder 200 comprises, in a symmetrical arrangement, a first deconvolutional hidden layer 201.2 and a second deconvolutional hidden layer 201.3.

The first convolutional hidden layer 200.2 has the same number of dimensions as the first deconvolutional hidden layer 201.2. Similarly, the second convolutional hidden layer 200.3 comprises the same number of dimensions as the second deconvolutional layer 201.3.

An auto-encoder thus comprises a symmetrical set of layers of neurons.

The hidden layers having the smallest number of dimensions, or central layers, in this case layers 200.3 and 201.3, are capable of exchanging data referred to as “code” or “latent vector” 210. The latent vector is a compressed version of the data received by the input layer 200.1.

The auto-encoder 200 according to the invention is capable of enhancing com-pressed data received at the input into enhanced data having fewer defects and being closer to the input images received and compressed by the encoder 110.

For this purpose, the first auto-encoder 200 is the result of supervised learning based on a first set of training data. The first set of training data comprises image pairs, each image pair consisting of:
an image of a given quality, especially of optimum quality, i.e. non-compressed. No restrictions are imposed on the resolution of an image of this type. The image of a given or optimum quality has no defects;
a compressed image obtained through the compression of the image of a given quality by a given compression algorithm, for example one of the compression algorithms mentioned above. Such a compressed image can have defects as de-scribed above.

The training data set preferably comprises image pairs that vary:
in terms of the compression algorithm applied to obtain the compressed image;
in terms of the compression ratio applied to obtain the compressed image; and/or
in terms of the type of defect which the compressed image has, including artefacts, a PSNR below a given threshold, for example less than 25, a missing part of the image, or other compression quality indicators, such as a maximum error or a mean square error (MSE).

The first set of training data comprises more than one hundred image pairs, preferably several thousand or tens of thousands of image pairs. The supervised learning then consists in submitting the compressed image at the input of the first 200 auto-encoder for each image pair. The image obtained at the output of the output layer 201.1 is com-pared with the optimum-quality image associated with the compressed image in order to estimate the difference, for example a mean square error between the image at the output of the first auto-encoder and the optimum image quality. The first auto-encoder 200 is then modified according to the determined deviation, for example by changing the characteristic values of one or more layers of neurons in order to reduce the calculated deviation.

In the example considered here, in which the encoder is integrated into a PCM or ECU of an automotive vehicle, and the decoder is integrated into a lighting device, the data from the first set of training data are image pairs representing the light beam to be implemented by automotive vehicle lighting devices. Such images are also called photometric images.

However, no restrictions are imposed on the data from the first set of training data which can be any type of image. In the example in which the decoder 120 is implemented in a remote server, the data from the set of training data can, for example, be images acquired by automotive vehicle cameras.

After training with the entire first set of training data, the mean square error is minimized and the first auto-encoder 200 is capable of reconstructing optimum-quality images from images having one or more defects, following their compression. The auto-encoder 200 can thus be implemented in the receiver 120 described above.

The first auto-encoder 200 can advantageously provide reuse, by deconvolutional layers of neurons, of characteristics of the convolutional layers of neurons. Such reuse can be permitted by at least one skip connection, connecting two non-consecutive convolutional layers of neurons of the first auto-encoder 200.

The first auto-encoder 200 comprises, for example, at least one skip connection 220.1 between a pair of layers having the same number of dimensions, or characteristics, each pair comprising a convolutional layer and a deconvolutional layer. In the example shown in FIG. 2, skip connections 220.1 can thus comprise a connection between the input layer 200.1 and the output layer 201.1, a connection between the first convolution-al hidden layer 200.2 and the first deconvolutional hidden layer 201.2, and a connection between the second convolutional hidden layer 200.3 and the second deconvolutional hidden layer 201.3.

Additionally or alternatively, the first auto-encoder 200 comprises at least one skip connection 220.2 between a pair of layers having different numbers of dimensions, or characteristics, each pair comprising a convolutional layer and a deconvolutional layer. In the example shown in FIG. 2, the skip connections 220.2 can thus comprise a connection between the first convolutional hidden layer 200.2 and the second deconvolutional hidden layer 201.3 and a connection between the second convolutional hidden layer 200.3 and the first deconvolutional hidden layer 201.2.

Such skip connections advantageously enable the performance of complex data processing operations with deep neural networks.

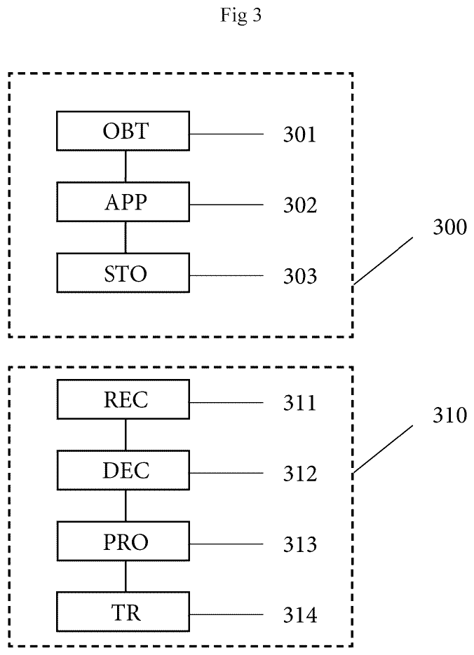

FIG. 3 shows a data transmission system according to embodiments of the invention.

The method comprises a preliminary phase 300, comprising a step 301 of obtaining the first set of training data, comprising image pairs as described above. No restrictions are imposed on the way in which the training data set is obtained. The optimum-quality images can originate from real-world situations or from simulations, for example.

In a step 302 of the preliminary phase 300, the first auto-encoder convolutional neural network 200 is trained by supervised learning based on the image pairs of the first set of training data obtained in the previous step 301. The first auto-encoder 200 thus obtained is capable of enhancing the quality of compressed data.

In a step 303 of the preliminary phase 300, the first auto-encoder convolutional neural network 200 is stored in a receiver, such as the receiver 120 described above. As explained above, the receiver 120 can be integrated into a lighting device for an automotive vehicle or a remote server of an automotive vehicle.

The processing method further comprises a current phase 310 comprising a step of reception 311 by the receiver 120 of compressed data via the communication channel 130 described above. In particular, the received data have been pre-compressed by the encoder 110 described above, with no restrictions imposed on the data compression technique.

In a step 312, the decompression module 121 decompresses the compressed data received in the preceding step 311, as described above.

In a step 313, the decompressed data are processed by the first auto-encoder 200 in order to be enhanced. Enhanced data are thus obtained at the end of step 313. Given the machine learning from which the first auto-encoder 120 originated, the enhanced data enable optimum image quality, close to the image initially compressed by the encoder 110.

The enhanced data can be transmitted by the receiver 120 in a step 314. The 120 receiver can transmit enhanced data, for example, to a memory for storage. In the embodiment in which the encoder 110 is integrated into a PCM and the receiver 120 is integrated into a signaling device, the enhanced data can advantageously be transmitted to a light source control module to implement the photometry corresponding to the output data.

FIG. 4 shows a data compression module 111 and a data decompression module 121 according to one embodiment of the invention.

As mentioned above, the compression module 111 and the decompression module 121 can be capable of implementing a compression/decompression algorithm such as linearization-based, gradient-based, JPG, PCA or other algorithms.

According to one variant shown in FIG. 4, the compression/decompression is implemented by means of a second auto-encoder convolutional neural network, also referred to below as the second auto-encoder, the compression and decompression modules 111 and 121 each comprising a part of the second auto-encoder. The compression module 111 thus comprises a first part 400 of the second auto-encoder, while the decompression module 121 comprises a second part 410 of the second auto-encoder.

The second auto-encoder is capable of compressing input data, in particular optimum-quality images, such as photometry images for a lighting device. The second auto-encoder can be built through unsupervised learning based on a second set of training data which differs from the first set of training data.

The second auto-encoder consists of an input layer 401 implemented in the encoder 110 and an output layer 411 implemented in the receiver 120, the input layer and the output layer having the same number of nodes or neurons, and therefore the same number of dimensions.

The auto-encoder system further comprises one or more convolutional hidden layers, each convolutional hidden layer having fewer dimensions than the number of dimensions of the input layer 401 and the output layer 411.

The convolutional hidden layers having the smallest number of dimensions, or central layers, are capable of exchanging a “code” or “latent vector,” and this latent vector is thus a compressed version of the input data.

The central layers can thus be shared between the encoder 112 and the decoder 123 in order to exchange compressed data, thus reducing the throughput requirements and the amount of data exchanged between the encoder and the decoder, while minimizing losses. The first part 400 thus comprises a central encoding layer 402 and the second part 410 comprises a central decoding layer 412. The central encoding layer 402 and the central decoding layer 412 are capable of exchanging a code or latent vector comprising a number of dimensions less than the input data.

The second auto-encoder is trained through unsupervised learning in such a way as to minimize the mean square error between the input data and the output data originating from the output layer, with a given number dimensions of the central layers, i.e. a given compression level.

For this purpose, the second training data set can be submitted to the second auto-encoder. The training data set can comprise a set of images, such as photometric lighting images for a vehicle in the example considered here. For each image in the second set of training data, the auto-encoder evaluates the mean square error between the image sub-mitted to the input layer 401 and the image supplied by the output layer 411, and varies the characteristics of its neurons as well as the number of neurons, or even the number of hidden layers, based on this mean square error, while retaining a restriction in order to obtain a latent vector having a given number of dimensions. The aim is thus to minimize the mean square error through learning.

The latent vector is a compressed version of the input data, with a compression ratio CR according to the following formula:

$$C R = ( Nbits * Im\_NbitsLV * LVdim ) / Nbits * Im\_Size ;$$

where Nbits is the number of bits with which each pixel of the input image is encoded, Im_Size is the size of the image in terms of the number of pixels, NbitsLV is the number of bits encoding each dimension of the latent vector, which is defined and is usual-ly equal to 32 bits, and LVdim is the number of dimensions of the latent vector.

More generally, Nbits*im_Size represents the size of the input data in terms of the number of bits.

For a given image size, the compression ratio CR can thus be varied by varying the number of dimensions LVdim of the latent vector.

The following compression ratios in particular can be obtained:

$$CR = 92 \% for LVdim = 516 ;$$

$$CR = 84 \% for LVdim = 1024 ;$$

$$CR = 52 \% for LVdim = 3072.$$

Thus, the lower the number of dimensions of the latent vector, the higher the compression ratio CR. The selection of a compression ratio can depend on quality indicators comparing the output data with the input data. Such indicators can comprise, for example, a peak signal-to-noise ratio (PSNR), or a mean square error (MSE).

For example, a number of dimensions of the latent vector providing a PSNR great-er than a given threshold, such as 30 for example, can be defined.

The first part 400 and the second part 410 of the auto-encoder convolutional neural network are thus obtained, and can be implemented in the encoder 110 and the decoder 120 respectively, during the preliminary phase 300 described above.

However, when the communication channel 130 has a limited throughput, as in the case, in particular, of a CAN bus, generally used between a PCM and a lighting device, high compression ratios, or even data reformatting, are required to enable the transport of the latent vector on the communication channel 130. As a result, decompressed data from the output layer 411 can have defects, thus making it advantageous to use the enhancement module 122 described above.

The PSNR value of the enhanced data can, in particular, be more than several points, in particular 5 points, compared with the decompressed data originating from the output layer 411 of the second auto-encoder. The other indicators such as the maximum error and the mean square error are also improved.

In the case where compression/decompression is not performed by the second au-to-encoder, but by one of the compression/decompression algorithms discussed above, the PSNR gain allowed by the enhancement module 122 can even reach 10 points. The other indicators such as the maximum error and the mean square error are also improved.

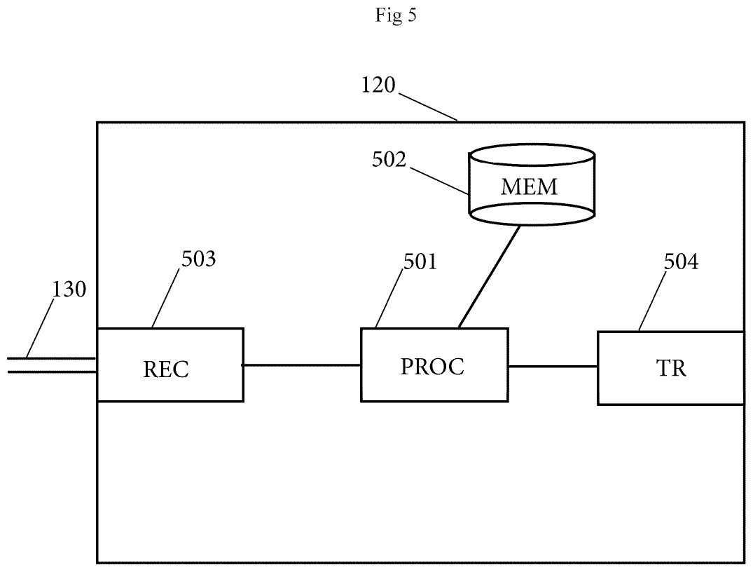

FIG. 5 shows the structure of a decoder or receiver 120 according to embodiments of the invention.

The decoder 120 comprises a processor 501 configured to communicate unidirectionally or bidirectionally, via one or more buses or via a wired connection, with a memory 502 such as a random access memory (RAM) or a read only memory (ROM) or any other type of memory (flash, EEPROM, etc.). As a variant, the memory 502 comprises several memories of the aforementioned types. The memory 502 is preferably a non-volatile memory.

The memory 502 permanently or temporarily stores all of the data generated by carrying out steps 311 to 314 of the data processing method described above. The memory 502 further stores the first auto-encoder convolutional neural network 200 in step 303 described above.

The memory 502 further stores a decompression algorithm or the second part 410 of the second convolutional neural network described with reference to FIG. 4.

The processor 501 is capable of executing instructions stored in the memory 502 in order to carry out steps 312 and 313 of the method illustrated with reference to FIG. 3. Alternatively, the processor 501 can be replaced with a microcontroller designed and configured to carry out steps 312 and 313 of the method according to FIG. 3.

The decompression module 121 as well as the enhancement module 122 shown above can thus be implemented by the processor 501 or the microcontroller. As a further alternative, one processor or one microcontroller is dedicated to the decompression function and another processor or microcontroller is dedicated to the enhancement function.

The receiver 120 can comprise an input interface 503 capable of receiving com-pressed data, in step 311 described above. No restrictions are imposed on the first input interface 503, which is functionally connected to the communication channel 130 de-scribed above.

The decoder 120 can further comprise a second interface, i.e. an output interface, 504 capable of transmitting the output data in step 314 described above.

The present invention is not limited to the embodiments described above as examples, but extends to other alternatives.

What is claimed is:

1. A data processing method comprising:
in a preliminary phase, supervised learning of a first auto-encoder convolutional neural network based on a first set of training data, the first set of training data consisting of image pairs including an image of a given quality and a compressed image obtained by compressing the image of a given quality, wherein the supervised learning is capable of minimizing a difference between an enhanced image obtained through the processing of a compressed image by the first auto-encoder convolutional neural network and the image of a given quality associated on a pair-by-pair basis with the compressed image;
storing the first auto-encoder convolutional neural network in a receiver;
wherein, during a current phase implemented by the receiver, the method further comprises:
receiving compressed data from a communication channel;
decompressing the compressed data into decompressed data;
applying the first auto-coder convolutional neural network to the compressed data in order to obtain enhanced data;
transmitting the enhanced data.

2. The data processing method as claimed in claim 1, wherein the decompression of the compressed data uses a linearization-based, gradient-based, JPG or PCA decompression algorithm.

3. The data processing method as claimed in claim 1, wherein the decompression of the compressed data is implemented through a processing by layers of neurons including an output layer and at least one convolutional hidden layer of a second auto-encoder convolutional neural network, the output layer includes a first number of dimensions and the at least one convolutional layer includes a second number of dimensions, the second number of dimensions being less than the first number of dimensions.

4. The method as claimed in claim 3, further comprising, in the preliminary phase, unsupervised learning of the second auto-encoder convolutional neural network based on a second set of training data.

5. The method as claimed in claim 1, wherein the compressed data and the enhanced data represent a photometry of a lighting device.

6. The method as claimed in claim 5, wherein the enhanced data are transmitted to a control module of a lighting device for an automotive vehicle.

7. The method as claimed in claim 5, wherein compressed data are received from an encoder of a central control module of an automotive vehicle and in which the communication channel is a CAN bus.

8. A receiver comprising:
a memory storing a first auto-encoder convolutional neural network capable of obtaining enhanced data from compressed data;
a first interface capable of receiving compressed data via a communication channel;
a processor configured to decompress the data into decompressed data, and to apply the first auto-encoder convolutional neural network to the compressed data in order to obtain enhanced data;
a second interface capable of transmitting the enhanced data.

9. A system comprising a receiver, an encoder capable of receiving input data, compressing the input data into compressed data and transmitting the compressed data to the receiver via a communication channel, wherein the receiver includes a memory storing a first auto-encoder convolutional neural network capable of obtaining enhanced data from the compressed data, a first interface capable of receiving the compressed data via the communication channel, a processor configured to decompress the compressed data into decompressed data, and to apply the first auto-encoder convolutional neural network to the compressed data in order to obtain enhanced data, and a second interface capable of transmitting the enhanced data.

10. The system as claimed in claim 9, wherein the encoder is integrated into a central control module of an automotive vehicle, the receiver is integrated into a lighting device of the automotive vehicle, the communication channel is a CAN bus, and the input data represent a lighting photometry.
